(19) United States
(12) Patent Application Publication
(10) Pub. No.: US 2025/0042755 A1
(43) Pub. Date: Feb. 6, 2025

(54) METHOD FOR MANUFACTURING BATTERY MATERIAL

(71) Applicants: Prime Planet Energy & Solutions, Inc., Tokyo (JP); THE UNIVERSITY OF TOKYO, Tokyo (JP)

(72) Inventors: Shinya SUZUKI, Kobe-shi (JP); Takanari OUCHI, Tokyo (JP)

(21) Appl. No.: 18/784,929

(22) Filed: Jul. 26, 2024

(30) Foreign Application Priority Data
Aug. 3, 2023 (JP) 2023-126805
Mar. 22, 2024 (JP) 2024-046956

(51) Int. Cl. C01D 15/08; C01D 15/02; C01D 15/04; C22B 1/08; C22B 3/00; C22B 7/00; H01M 4/38; H01M 4/505; H01M 4/525; H01M 10/54

(52) U.S. Cl. CPC C01D 15/08; C01D 15/02; C01D 15/04; C22B 1/08; C22B 7/008; C22B 23/0446; H01M 4/382; H01M 4/505; H01M 4/525; H01M 10/54; C01P 2006/40

(57) ABSTRACT

According to the present disclosure, a recovery efficiency of Li from a recovery object such as a used lithium ion secondary battery can be improved. The manufacture method disclosed herein includes a preparation step S11 of preparing a recovery object containing at least Li, and a chlorination heating step S12 of heating the recovery object together with a non-metal chlorine compound to produce LiCl. Since LiCl is soluble in water, Li can be easily recovered from the recovery object. That means, the technology disclosed herein makes it possible to separate Li from the recovery object immediately after the chlorination heating step S12, contributing to significant improvement of Li recovery efficiency.

### CROSS REFERENCE TO RELATED APPLICATION

This application claims priority based on Japanese Patent Application No. 2023-126805 filed Aug. 3, 2023 and Japanese Patent Application No. 2024-46956 filed Mar. 22, 2024, the entirety of which is herein incorporated by reference.

### BACKGROUND OF THE DISCLOSURE

### 1. Field

The technology disclosed herein relates to a method for manufacturing a battery material.

### 2. Background

Lithium ion secondary batteries are widely used in various fields. Various materials including valuable metals such as Ni and Co are used for these lithium ion secondary batteries. For example, as positive electrode active materials, lithium transition metal composite oxides are used, such as lithium-nickel composite oxides, lithium-cobalt composite oxides, lithium-nickel-cobalt composite oxides, and lithium-nickel-cobalt-manganese composite oxides. Aluminum and the like are used for a positive electrode core. On the other hand, carbon materials and the like are used for a negative electrode active material. Copper and the like are used for a negative electrode core. Furthermore, aluminum and the like are also used for battery cases for accommodating these electrodes.

In recent years, development of recovery technologies has been promoted to recover valuable metals from used batteries, process end materials, and the like to reuse them as battery materials. In this recovery technology, a recovery object (used batteries, process end materials, etc.) is first roasted. Then, the roasted recovery object is subjected to acid leaching. This makes it possible to dissolve metal components (Li, Ni, Co, Mn, Al, Cu, etc.) in the recovery object in an acid liquid to obtain a metal solution. Also, this acid leaching makes it possible to separate carbon components from the recovery object. On the other hand, the metal solution after the acid leaching is subjected to various separation treatments (neutralization deposition, solvent extraction, etc.). Thereby, desired metal components can be extracted and reused as battery materials.

Examples of this recovery technology are disclosed in Japanese Patent No. 2020-164971 and Japanese Patent No. 2020-105598. For example, the treatment method described in Japanese Patent No. 2020-164971 includes: a leaching step of leaching a lithium ion battery scrap (recovery object) with acid to obtain a post-leaching liquid containing at least fluoride ions and aluminum ions; a neutralization step of neutralizing the post-leaching liquid to within a range of pH 5.3 to 5.5 and removing at least a part of aluminum ions from the post-leaching liquid to obtain a post-neutralization liquid; and an extraction step of subjecting the post-neutralization liquid to solvent extraction to extract the remaining aluminum ions from the post-neutralization liquid. Furthermore, the treatment method described in Japanese Patent No. 2020-164971 includes a recovery step of recovering valuable metals (Ni, Co, Li) from the extractant remaining after the extraction step.

### SUMMARY

However, the conventional recovery technology described above has had a problem of a low lithium (Li) recovery ratio. Specifically, in the conventional technology, Al is removed by neutralizing a metal solution after acid leaching. Subsequently, valuable metals other than Li (Ni, Co, Mn, etc.) are sequentially recovered using a solvent extraction method. Then, Li is recovered from a liquid remaining after the solvent extraction. That means, the conventional technology includes various separation treatments before recovery of Li. For this reason, in the conventional technology, it has been difficult to achieve a high Li recovery ratio because Li is removed by the separation treatment before recovery of Li.

To resolve the above problems, a method for manufacturing a battery material having a configuration described below (hereinafter simply referred to as “manufacture method”) is provided.

The method for manufacturing the battery material disclosed herein includes a preparation step of preparing a recovery object containing at least Li, and a chlorination heating step of heating the recovery object together with a non-metal chlorine compound to produce LiCl.

The manufacture method having the above configuration includes a chlorination heating step, in which the recovery object is heated in an environment with a non-metal chlorine compound. Thereby, Li in the recovery object is chlorinated to produce lithium chloride (LiCl). Since LiCl is soluble in water, Li can be easily recovered from the recovery object. That means, the technology disclosed herein makes it possible to directly separate Li from the recovery object immediately after the chlorination heating step, contributing to significant improvement of Li recovery efficiency.

### BRIEF DESCRIPTION OF THE DRAWINGS

FIG. 1 is a schematic longitudinal sectional view of an internal structure of a lithium ion secondary battery;

FIG. 2 is a schematic perspective view of an electrode body of the lithium ion secondary battery illustrated in FIG. 1;

FIG. 3 is a flowchart illustrating a method for manufacturing a battery material according to an embodiment; and

FIG. 4 is a flowchart illustrating a roasting step in a manufacture method according to an embodiment in detail.

### DETAILED DESCRIPTION OF THE PREFERRED EMBODIMENTS

Hereinafter, an embodiment of a technology disclosed herein will be explained with reference to the figures. Matters other than those specifically mentioned in this specification, which are necessary for implementing the technology disclosed herein may be understood as design matters for those skilled in the art, based on the prior art in the field. The technology disclosed herein can be implemented based on the contents disclosed in this specification and the technical knowledge in the field.

### 1. Recovery Object

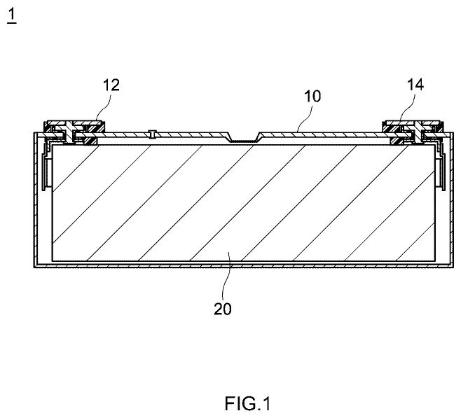

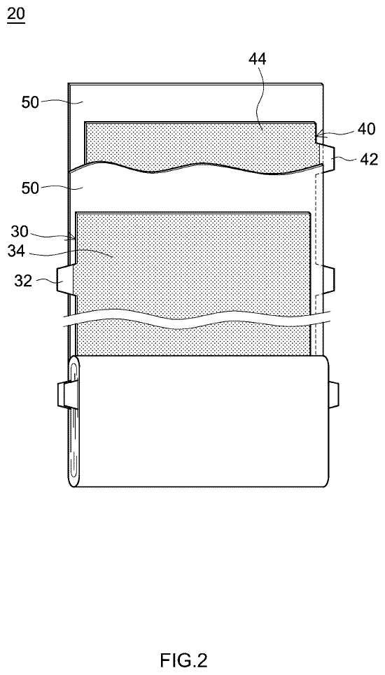

In the method for manufacturing the battery material according to this embodiment, a battery material (typically, a material for a positive electrode active material of lithium ion secondary batteries, a precursor of a positive electrode active material, and a positive electrode active material) is manufactured by recovering valuable metals such as lithium (Li) from a given recovery object. Herein, an example of the recovery object is a used lithium ion secondary battery. This lithium ion secondary battery will be specifically explained below. FIG. 1 is a schematic longitudinal sectional view of an internal structure of a lithium ion secondary battery. FIG. 2 is a schematic perspective view of an electrode body of the lithium ion secondary battery illustrated in FIG. 1.

As illustrated in FIG. 1, a lithium-ion secondary battery 1 includes a case 10, an electrode body 20, and an electrolyte (not illustrated).

### (1) Case

The case 10 is a box-like container. The case 10 accommodates the electrode body 20 and the electrolyte. For the case 10, e.g. a metal material having a certain strength (aluminum (Al) etc.) is used. Also, a positive electrode terminal 12 and a negative electrode terminal 14 are attached to the case 10. The positive electrode terminal 12 and the negative electrode terminal 14 are connected to the electrode body 20 inside the case 10. Specifically, the positive electrode terminal 12 is connected to a positive electrode plate 30 (see FIG. 2) of the electrode body 20. For this positive electrode terminal 12, aluminum (Al) or the like is used. On the other hand, the negative electrode terminal 14 is connected to the negative electrode plate 40 of the electrode body 20. For this negative electrode terminal 14, copper (Cu) or the like is used.

### (2) Electrode Body

The electrode body 20 is a power generating element of the lithium ion secondary battery 1. As illustrated in FIG. 2, the electrode body 20 includes the positive electrode plate 30, the negative electrode plate 40, and a separator 50. The electrode body 20 illustrated in FIG. 2 is a wound electrode body. This wound electrode body is fabricated by laminating the positive electrode plate 30, the negative electrode plate 40, and the separator 50 to form an elongated belt-like laminate and then winding the laminate. However, the structure of the electrode body 20 is not particularly limited, and the electrode body 20 may have another conventionally known structure (laminated electrode body etc.).

The positive electrode plate 30 includes a positive electrode core 32 that is a conductive metal foil, and a positive electrode active material layer 34 provided on a surface of the positive electrode core 32. For the positive electrode core 32, aluminum (Al) and the like is used. The positive electrode active material layer 34 is a composite material layer including a positive electrode active material, a conductive material, a binder, and the like. The positive electrode active material is a metal material containing at least lithium (Li). Examples of this positive electrode active material include lithium transition metal composite oxides such as a lithium-nickel composite oxide, a lithium-cobalt composite oxide, a lithium-manganese composite oxide, a lithium-nickel-manganese composite oxide, a lithium-manganese-cobalt composite oxide, a lithium-nickel-cobalt composite oxide, and a lithium-nickel-manganese-cobalt composite oxide. Other examples of the positive electrode active material include lithium transition metal phosphate compounds such as lithium iron phosphate, lithium manganese phosphate, and lithium ferromanganese phosphate. The manufacture method according to this embodiment makes it possible to improve a recovery efficiency of Li from the recovery object including these positive electrode active materials. In the manufacture method according to this embodiment, other valuable metals such as Ni, Co, and Mn can also be efficiently recovered from the recovery object. For this reason, a lithium transition metal composite oxide containing Ni, Co, and Mn is particularly preferable as the positive electrode active material in the recovery object. Examples of the conductive material include carbon materials such as acetylene black and graphite. Examples of the binder include resin materials such as polyvinylidene fluoride (PVdF).

On the other hand, the negative electrode plate 40 has a negative electrode core 42 that is a conductive metal foil, and a negative electrode active material layer 44 provided on a surface of the negative electrode core 42. For the negative electrode core 42, copper (Cu) and the like is used. The negative electrode active material layer 44 is a composite material layer containing a negative electrode active material, a binder, a thickener, and the like. Examples of the negative electrode active material include carbon materials such as black lead, hard carbon, and soft carbon. Other examples of the negative electrode active material include lithium titanate (LTO), silicon carbide (SiC), a composite containing carbon and silicon, and silicon oxide (SiOx). Examples of the binder include resin materials such as styrene-butadiene rubber (SBR). Examples of the thickener include resin materials such as carboxymethylcellulose (CMC).

The separator 50 is an insulating sheet interposed between the positive electrode plate 30 and the negative electrode plate 40. For this separator 50, e.g. a resin material such as polyethylene (PE), polypropylene (PP), polyester, cellulose, and polyamide is used. A heat-resistant layer including an inorganic filler may be formed on the surface of the separator 50. Examples of the inorganic filler include inorganic oxides such as aluminum oxide, magnesium oxide, silicon oxide, and titanium oxide; nitrides such as aluminum nitride and silicon nitride; metal hydroxides such as calcium hydroxide, magnesium hydroxide, and aluminum hydroxide; as well as clay minerals such as mica, talc, boehmite, zeolite, apatite, and kaolin.

### (3) Electrolyte

The electrolyte is interposed between the positive electrode plate 30 and the negative electrode plate 40. Thereby, charge carriers (Li ions) can be transferred between the positive electrode plate 30 and the negative electrode plate 40. Examples of the electrolyte include a nonaqueous electrolytic solution and a gel electrolyte. As the electrolyte, an electrolyte usable in a lithium ion secondary battery can be used without any particular limitation, and the technology disclosed herein is not limited.

As described above, the lithium ion secondary battery 1 has been explained as an example of the recovery object in the manufacture method according to this embodiment. However, the manufacture method disclosed herein is not limited to the method using, as a recovery object, the lithium ion secondary battery 1 having the above configuration. For example, when fabricating an electrode body at a manufacture site of lithium ion secondary batteries, a part of a positive electrode plate is cut out in some cases. This cut part (process end material) of the positive electrode plate also contains Li and therefore can be used as a recovery object in the manufacture method disclosed herein. Furthermore, at the manufacture site of lithium ion secondary batteries, some defects may occur on fabricated electrode bodies, and therefore the electrode bodies cannot be used for products in some cases. Such an electrode body also contains Li and therefore can be used as a recovery object. That means, the recovery object in the manufacture method disclosed herein is not particularly limited to a specific structure as long as the recovery object contains Li.

### 2. Method for Manufacturing Battery Material

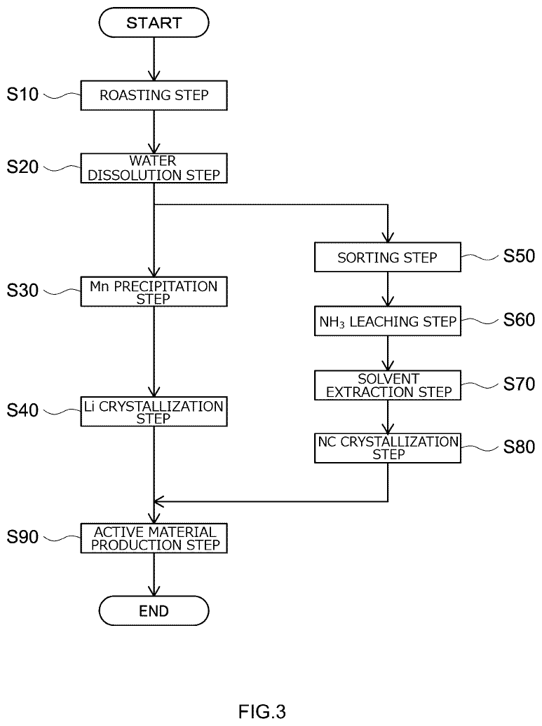

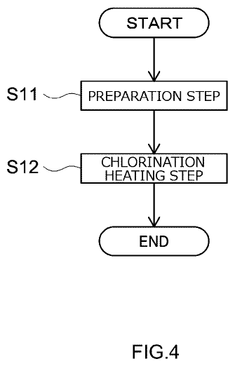

A method for manufacturing the battery material according to this embodiment will be explained below. FIG. 3 is a flowchart illustrating the manufacture method according to this embodiment. FIG. 4 is a flowchart illustrating a roasting step in FIG. 3 in detail.

As illustrated in FIG. 3, the method for manufacturing the battery material according to this embodiment includes a roasting step S10, a water dissolution step S20, an Mn precipitation step S30, an Li crystallization step S40, a sorting step S50, an NH₃ leaching step S60, a solvent extraction step S70, a nickel-cobalt (NC) crystallization step S80, and an active material production step S90. Each step will be explained below.

### (1) Roasting Step S10

In this step, a recovery object is heated at a predetermined temperature. This makes it possible to remove liquid components (electrolytic solution etc.) in the recovery object and to carbonize resin components (binder, separator, etc.). When the charged lithium ion secondary battery 1 is used as a recovery object, the battery function can be deactivated by conducting the roasting step S10. Thereby, the subsequent steps can be conducted safely.

As illustrated in FIG. 4, the roasting step S10 in this embodiment includes a preparation step S11 and a chlorination heating step S12. Thereby, the Li recovery efficiency can be significantly improved. Each step will be specifically explained below.

### (a) Preparation Step S11

In this step, a recovery object containing at least Li is prepared. As described above, the “recovery object” in the technology disclosed herein is not limited to completely-manufactured lithium ion secondary batteries but includes process end materials and defective parts (electrode body etc.). Since the details of the recovery object have been already explained above, repeated explanations are omitted. The manufacture method according to this embodiment makes it possible to recover (manufacture) not only lithium (Li) described above but also nickel (Ni), cobalt (Co), manganese (Mn), and the like.

### (b) Chlorination Heating Step S12

In the chlorination heating step S12, a recovery object is heated together with a non-metal chlorine compound. Thereby, Li in the recovery object is reacted with Cl in the non-metal chlorine compound to produce lithium chloride (LiCl). If the recovery object contains Mn, this Mn can also be reacted with Cl to produce manganese chloride (MnCl₂). On the other hand, since Li and Mn are preferentially chlorinated in this step, metal elements (Ni, Co, Al, and Cu) are hardly chlorinated.

The “non-metal chlorine compound” in this specification refers to a chlorine compound free from metal elements. The non-metal chlorine compound is not particularly limited as long as it can decompose during heating to feed Cl to Li in the recovery object, and a conventionally-known compound can be selected as appropriate. Examples of the non-metal chlorine compound include inorganic chlorine compounds such as hydrogen chloride (HCl), ammonium chloride (NH₄Cl), ammonium perchlorate (NH₄ClO₄), perchloric acid (HClO₄), chloric acid (HClO₃), chlorite (HClO₂), and hypochlorous acid (HClO). Other examples of the non-metal chlorine compound include organic chlorine compounds such as chloromethane, dichloromethane, trichloromethane (chloroform), and tetrachloroethylene. These non-metal chlorine compounds can feed Cl without contamination of other metallic elements as impurities into the recovery object.

A state of the non-metal chlorine compound is not particularly limited as long as it can appropriately feed Cl to the recovery object. For example, if the non-metal chlorine compound is a gas, a heating gas described later should be mixed with the non-metal chlorine compound, which is fed to the heating furnace. If the non-metal chlorine compound is a liquid or solid, a mixture of the recovery object and the non-metal chlorine compound should be heated. In any case, Cl in the non-metal chlorine compound can be appropriately fed to the recovery object.

The heating temperature in this step may be 500° C. or higher, 525° C. or higher, 550° C. or higher, or 575° C. or higher. There is a tendency that as the heating temperature is more improved, LiCl is more easily produced. In particular, the heating temperature is preferably 600° C. or higher, more preferably 800° C. or higher, particularly preferably 900° C. or higher. At this temperature, the Li recovery ratio is markedly improved. On the other hand, in terms of the production of LiCl, the upper limit of the heating temperature is not particularly limited, and may be 1500° C. or lower, 1400° C. or lower, or 1300° C. or lower. Considering reduction of the cost required for the heating treatment, and the like, the upper limit of the heating temperature is preferably 1200° C. or lower, more preferably 1100° C. or lower, particularly preferably 1000° C. or lower.

Although not limiting the technology disclosed herein, it is preferable to heat the recovery object under an inert atmosphere in this step. Thereby, production of metal oxides (lithium oxide (Li₂O) etc.) can be suppressed to improve the chloride selectivity. Specific examples of an inert gas used in this step include argon gas and nitrogen gas. The term “inert atmosphere” in this specification refers to a heating atmosphere mainly containing the above-described inert gas. In other words, the “inert atmosphere” in this specification is not limited to a completely inert atmosphere with 100% inert gas content (0% oxygen element content) but may contain a trace amount of oxygen element. Specifically, the heating atmosphere in this step only needs to contain 5% or less (preferably 3% or less, more preferably 1% or less, even more preferably 0.5% or less, particularly preferably 0.1% or less) of oxygen element. However, when the recovery object contains a sufficient amount of reducing component (carbon (C) etc.), LiCL can be appropriately produced even if oxygen element content exceeds the above range.

In this step, it is preferable to provide a water trap, which allows a used heating gas (exhaust gas discharged from the heating furnace) to pass through water. Thereby, LiCL in the exhaust gas can be collected by the water trap to further improve the Li recovery ratio. Water through which the exhaust gas has been passed should be mixed with an Li solution prepared in the water dissolution step S20 described later. Consequently, Li can be efficiently recovered.

### (2) Water Dissolution Step S20

Subsequently, in the water dissolution step S20, the recovery object after the chlorination heating step S12 is mixed with water. As described above, the recovery object after the chlorination heating step S12 contains LiCl. This LiCl is easily dissolved in water such as pure water and ion-exchanged water. As a result, in this step, LiCl can be dissolved in water to obtain an Li solution. Thus, in the manufacture method according to this embodiment, Li can be easily separated from the recovery object immediately after the chlorination heating step S14, resulting in an Li solution containing Li at high purity.

The immersion time in this step is preferably 10 minutes or longer, 15 minutes or longer, 20 minutes or longer, particularly preferably 25 minutes or longer. Thereby, LiCl in the recovery object can be sufficiently dissolved in water. If the immersion time is longer than 30 minutes, almost whole LiCl in the recovery object can be dissolved in water. For this reason, considering the producibility, the upper limit of the immersion time is preferably 120 minutes or shorter, 90 minutes or shorter, 60 minutes or shorter, particularly preferably 45 minutes or shorter. The temperature of water in this step is not particularly limited and may be set as appropriate within a range of 10° C. to 60° C.

### (3) Mn Precipitation Step S30

When the recovery object contains Mn, MnCl₂ may be produced in the chlorination heating step S12. Since this MnCl₂ is also soluble in water, the Li solution after the water dissolution step S20 will contain Mn. In this step, Mn is recovered from the Li solution. For example, in this step, a sodium hydroxide aqueous solution is added to the Li solution. This makes it possible to precipitate manganese hydroxide (Mn(OH)₂) from the Li solution. Then, the Li solution is filtered to recover Mn.

### (4) Li Crystallization Step S40

In this step, an Li compound crystal is precipitated from the Li solution. In this step, any conventionally known crystallization treatment can be adopted without any particular limitation. For example, in this step, sodium carbonate should be added to the Li solution. Thereby, a lithium carbonate (Li₂CO₃) crystal can be precipitated from the Li solution. Note that the Li compound produced in this step is not limited to lithium carbonate. For example, lithium hydroxide (LiOH) may be produced as the Li compound as necessary. In the production of lithium hydroxide, lithium carbonate precipitated from the metal solution is first dissolved (or suspended) in a predetermined solvent. Then, calcium hydroxide is added to this solution. Subsequently, the solvent is evaporated off as necessary. Thus, a lithium hydroxide crystal can be precipitated.

As described above, in the manufacture method according to this embodiment, Li can be recovered from the metal solution (Li solution) produced after the roasting step S10. That means, in the manufacture method according to this embodiment, the number of steps from the completion of the roasting step S10 to the recovery of Li can be significantly decreased. Thus, a high Li recovery ratio can be achieved.

### (5) Sorting Step S50

On the other hand, metallic elements (Ni, Co, Al, Cu, etc.) that have not chlorinated in the roasting step S10 remain in the solid content (recovery object) after the water dissolution step S20. If other valuable metals (Ni and Co) are contained in the remaining metals, it is preferable to recover these valuable metals. In contrast, in the manufacture method according to this embodiment, the solid content after the water dissolution step S20 is subjected to the sorting step S50. In this step, each component contained in the recovery object after the water dissolution step S20 is sorted by a sieve. For example, when the process end material of the positive electrode plate 30 is to be recovered, the positive electrode core 32 should be sorted from the process end material by a sieve and removed from the recovery object. When the electrode body 20 is to be recovered, in addition to the positive electrode core 32, the negative electrode plate 40 should also be removed from the recovery object. Furthermore, when the lithium ion secondary battery 1 is to be recovered, in addition to the positive electrode core 32 and negative electrode plate 40, the case 10 should also be removed from the recovery object. Thereby, the content of impurities (Al, Cu, etc.) in the recovery object is decreased, contributing to improvement of the recovery efficiency of the valuable metals (Co, Ni). As in this embodiment, it is preferable that the sorting step is conducted after the water dissolution step. Thus, LiCl that has adhered to the objects to be removed (positive electrode core, negative electrode plate, case, etc.) in the sorting step can be recovered in advance.

In this step, the recovery object may be crushed as necessary. Thereby, the sorting efficiency of each component can be improved. For example, when the lithium ion secondary battery 1 is to be recovered, the case 10 and the electrode body 20 should be crushed. This facilitates removal of the case 10, the positive electrode core 32, and the negative electrode plate 40 from the recovery object.

The sorting step S50 is not intended to completely remove impurities such as Al and Cu from the recovery object. As described later in detail, even if impurities remain in the recovery object, impurities can be sufficiently removed in subsequent steps (NH₃ leaching step S60, solvent extraction step S70, etc.). That means, this step may be arbitrarily omitted as necessary. For example, when using a recovery object containing a small amount of impurities (process end material of positive electrode plate 30, etc.), valuable metals can be efficiently recovered even if this step is omitted.

### (6) NH₃ Leaching Step S60

In this step, the solid content after the water dissolution step S20 (e.g. after the sorting step S50) is immersed in an ammonia aqueous solution. Thereby, among the metal elements (Ni, Co, Al, Cu) in the solid content, Ni, Co, Cu, and the like are dissolved in the ammonia aqueous solution. This makes it possible to obtain a metal solution containing Ni, Co, and Cu. On the other hand, Al difficult to dissolve in the ammonia aqueous solution remains in the solid content. Consequently, Al as impurity can be easily removed.

### (7) Solvent Extraction Step S70

In this step, each of Co and Ni is extracted from the metal solution using a solvent extraction method. Thereby, a Co solution and an Ni solution can be each obtained. Also in this step, impurities (Al, Cu, etc.) that have contaminated the metal solution can be separated. Specifically, the solvent extraction step S70 according to this embodiment includes a Co extraction step and an Ni extraction step. Each step will be specifically explained below.

### (a) Co Extraction Step

In this step, an organic solvent (first extractant) with a high extractability for Co and a low extractability for Ni, Al, and Cu is added to the metal solution. Thereby, Co can be separated from the metal solution and dissolved in the first extractant to obtain a Co solution. Specific examples of the first extractant include phosphonic acid esters such as 2-ethylhexyl (2-ethylhexyl) phosphonate (PC-88A).

Also in this step, the Co solution (first extractant containing Co) after the extraction may be subjected to a stripping treatment. In this stripping treatment, the Co solution (organic phase) and an acidic aqueous solution are first mixed by stirring using a mixer or the like. Then, the two solutions are allowed to stand until they are separated. Thereby, Co is dissolved in the acidic aqueous solution to obtain an aqueous Co solution. Examples of the acidic aqueous solution for the stripping treatment include sulfuric acid and hydrochloric acid (especially sulfuric acid).

### (b) Ni Extraction Step

In this step, an organic solvent (second extractant) with a high extractability for Ni and a low extractability for Al and Cu is added to the metal solution. Thereby, Ni can be separated from the metal solution and dissolved in the second extractant to obtain an Ni solution. Specific examples of the second extractant include carboxylic acid extractants such as neodecanoic acid and naphthenic acid. The Ni solution (second extractant containing Ni) after the extraction may also be subjected to a stripping treatment. As a result, an aqueous Ni solution can be obtained. Since the stripping procedure has been already explained above, repeated explanations are omitted.

### (8) NC Crystallization Step S80

In this step, a crystal of a metal compound containing Ni and Co is precipitated. In this step, a conventionally known crystallization treatment can be adopted without any particular limitation. For example, when performing a stripping treatment in each of the Co extraction step and the Ni extraction step, an aqueous mixture of the Co and Ni solutions is prepared. Thereby, a mixture containing Ni and Co can be obtained. The pH of this mixture is then controlled to be alkaline to precipitate a metal compound crystal. In the preparation of the mixture, a mixing ratio of Ni and Co should be changed as necessary. Then, in adjusting the pH, the mixture, together with an alkaline solution (ammonia water, sodium hydroxide solution), is dripped into a reaction vessel. Consequently, an NiCo hydroxide can be crystallized.

### (9) Active Material Production Step S90

In this step, a battery material (positive electrode active material) is produced using the Li compound, Mn compound, and NiCo compound obtained in each step described above. Specifically, the NiCo compound (NiCo hydroxide), Mn compound (Mn(OH)₂), and Li compound (Li₂CO₃, etc.) are first mixed in a predetermined ratio. Then, this mixture is baked to manufacture the positive electrode active material (lithium transition metal composite oxide) for lithium ion secondary batteries.

The method for manufacturing the battery material according to this embodiment has been explained above. As described above, in the roasting step S10 in the manufacture method according to this embodiment, the chlorination heating step S12 is conducted, in which the recovery object is heated under an environment with a non-metal chlorine compound. Thereby, the Li in the recovery object is chlorinated to produce lithium chloride (LiCl). Since LiCl is soluble in water, Li can be easily recovered from the recovery object. That means, the technology disclosed herein makes it possible to directly separate Li from the recovery object immediately after the roasting step S10. As a result, the number of steps from the completion of the roasting step S10 to the recovery of Li can be significantly decreased, and therefore a high Li recovery ratio can be achieved.

### 3. Other Embodiments

One embodiment of the technology disclosed herein has been explained above. The technology disclosed herein is not limited to the embodiment described above but includes other embodiments with variously-changed configurations. Other examples of embodiments of the technology disclosed herein will be explained below.

In the manufacture method according to the embodiment described above, the steps from the sorting step S50 to the active material production step S90 are conducted after the roasting step S10. However, the explanation on the embodiment described above is not intended to limit the steps after the roasting step. That means, in the manufacture method disclosed herein, steps after the roasting step can be arbitrarily added, deleted, and modified as necessary.

### (1) Omission of Mn Precipitation Step

For example, in the manufacture method according to the embodiment described above, the Mn precipitation step S30 is conducted before the Li crystallization step S40 because the Li solution after the water dissolution step S20 contains Mn. However, if the recovery object does not contain Mn, a Li solution containing only Li can be obtained in the water dissolution step S20. In this case, the Mn precipitation step S30 can be omitted.

### (2) Omission of NH₃ Leaching Step and Subsequent Steps

In the manufacture method according to the embodiment described above, valuable metals such as Ni and Co are recovered by conducting the NH₃ leaching step S60 to the NCM crystallization step S80. However, if the recovery object does not contain Ni and Co, the NH₃ leaching step and the subsequent steps can be omitted. The NH₃ leaching step and the subsequent steps may be modified as appropriate depending on the type of the metallic element contained in the recovery object.

### (3) Modification of Solvent Extraction Step

The specific procedure in the solvent extraction step S70 may be modified as appropriate. For example, the solvent extraction step S70 in the embodiment described above includes a Co extraction step and an Ni extraction step. Thereby, the Co solution and Ni solution can be separately extracted. However, in the solvent extraction step S70, Ni and Co may be simultaneously extracted. Specifically, an organic solvent with a high extractability for Ni and Co and a low extractability for Al and Cu should be added to the metal solution. This simultaneous extraction of Ni and Co can shorten the step to improve producibility.

### (4) Omission of Solvent Extraction Step

In the manufacture method according to the embodiment described above, a lithium ion secondary battery is used as a recovery object. Such a recovery object contains Cu derived from the negative electrode core. Thus, the metal solution produced in the NH₃ leaching step S60 contains Cu in addition to Ni and Co. In this case, it is preferable to remove Cu from the metal solution by conducting the solvent extraction step S70 as in the embodiment described above. On the other hand, when using a recovery object free from Cu (process end material of positive electrode plate etc.), the metal solution produced in the NH₃ leaching step S60 does not contain Cu. In this case, the solvent extraction step S70 can be omitted, and the metal solution obtained in the NH₃ leaching step S60 can be subjected to the NC crystallization step S80.

### (5) Addition of Li Separation Step

The Li solution before the Li crystallization step S40 may be subjected to an Li separation step. Specifically, the Li solution contains Li as a main component, but this Li solution may contain other metal components (Cu, Al, etc.). In the Li separation step, impurities are removed from the Li solution. Thus, a high-purity Li compound can be obtained in the Li crystallization step S40. The means for preparing the Li solution is not particularly limited, and any conventionally known means such as solvent extraction and ion exchange should be adopted as appropriate.

### (6) Addition of Li Concentration Step

The Li solution after the Li separation step may be subjected to an Li concentration step. In this Li concentration step, the Li solution is heated to evaporate the solvent. Thereby, a high concentration Li solution can be obtained, so that the crystallization efficiency in the Li crystallization step S40 can be improved. This Li concentration step may be conducted for a metal solution that has not been subjected to the Li separation step. For example, if impurities are sufficiently removed in the water dissolution step S20 and the Mn precipitation step 30, only the Li concentration step may be conducted without the Li separation step. Also in this case, a high concentration Li solution can be obtained.

### (7) Modification of NC Crystallization Step

In the embodiment described above, a mixture containing Ni and Co is subjected to the NC crystallization step S80. This step makes it possible to crystallize a metal compound containing Ni and Co (NiCo hydroxide). However, each metal compound may be separately crystallized from the Co solution and the Ni solution. For example, if the stripping is performed with sulfuric acid as in the above embodiment, a cobalt sulfate (CoSO₄) crystal can be precipitated from the Co solution by removing and cooling the solvent as necessary. Also, a nickel sulfate (NiSO₄) crystal is precipitated from the Ni solution. The NC crystal synthesized from these sulfate crystals is baked together with Li and Mn compounds to produce a battery material (positive electrode active material).

In the embodiment described above, an NiCo hydroxide is crystallized from a mixture containing Ni and Co. However, a metal compound containing Ni, Co, and Mn (NiCoMn hydroxide) may be produced as a precursor of the positive electrode active material. Specifically, manganese hydroxide (Mn(OH)₂) obtained in the Mn precipitation step S30 is added to the mixture containing Ni and Co to obtain a mixture containing Ni, Co, and Mn. Then, this mixture is subjected to a crystallization treatment to produce a metal compound containing Ni, Co, and Mn (NiCoMn hydroxide). This NiCoMn hydroxide is baked together with a Li compound to produce a positive electrode active material.

### Test Examples

Test examples related to the technology disclosed herein will be explained below. The contents of the test examples described below are not intended to limit the technology disclosed herein.

### <First Test

In this test, a positive electrode plate is used as a recovery object, and the recovery object is subjected to a roasting step. Specifically, as the positive electrode plate, a positive electrode core (Al foil) with a surface coated with a positive electrode active material layer was used. As the positive electrode active material in this test, a lithium-nickel-cobalt-manganese composite oxide (LiNi_{1/3}Co_{1/3}Mn_{1/3}O₂) was used. Then, this positive electrode plate was cut out into a 2 cm×4 cm sheet, this sheet was used as a test sample.

In this test, the test sample was then heated together with a non-metal chlorine compound. Specifically, the test sample was put into a crucible, which was placed in an electric furnace. The temperature inside the furnace was then raised to 600° C. while feeding a mixed gas of HCl gas and Ar gas. A water trap was placed in the exhaust pipe of the electric furnace, and an exhaust gas after the heating was passed through water. In this step, the temperature increase rate was set at 5° C./min. The feeding rate of the mixed gas was set to 4.2 L/min. The sample was roasted while maintaining the furnace temperature at 600° C. for 1 hour. Subsequently, the furnace temperature was decreased to 50° C., and then the test sample was recovered. The mixed gas was continuously fed to the furnace until the sample was recovered.

Subsequently, in this test, the roasted test sample was immersed in water for 30 minutes, and then water was filtered to obtain an Li solution. Then, the collected water from the water trap of the electric furnace was added to the Li solution. Then, a 30 wt % NaOH aqueous solution was dripped into the Li solution until the pH of the Li solution reached 11. The precipitate (Mn(OH)₂) was collected to remove Mn from the Li solution. Then, a 10 wt % Na₂CO₃ aqueous solution was added to the Li solution to precipitate lithium carbonate (Li₂CO₃). Whole precipitated Li₂CO₃ was collected and a quantity of Li was measured by inductively coupled plasma (ICP). The Li recovery ratio was calculated based on the following equation (1). In Formula (1), the “Li quantity before roasting” refers to an Li quantity determined by analyzing a reference sample cut out from the positive electrode plate by ICP.

$$Li recovery ratio = ( Li quantity in the precipitated {Li}_{2} {CO}_{3} / Li quantity in \\ the positive electrode plate before roasting ) \times 100 \qquad ( 1 )$$

As a result of the test described above, surprisingly, a very high Li recovery ratio of 90% or higher was confirmed. Although details are omitted, it has been confirmed that when Li is recovered from a liquid remaining after neutralization precipitation or solvent extraction as in Japanese Patent No. 2020-164971, the Li recovery ratio is about 20 to 60%. This indicates that, in the roasting step, production of LiCl by heating of the recovery object together with a non-metal chlorine compound can contribute to significant improvement of the Li recovery efficiency. This may be because multiple separation steps as in the conventional technology can be omitted and Li can be directly separated from the recovery object immediately after the roasting step.

### <Second Test>

In the second test, Li recovery ratios of two samples were measured with different heating temperatures in the chlorination heating step. In this test, the recovery ratios of metals other than Li were also measured. The test will be specifically explained below.

### 1. Sample Preparation

### (1) Sample 1

To prepare Sample 1, an Li solution was obtained under the same condition as in the first test. That means, to prepare Sample 1, a positive electrode plate was roasted together with a non-metal chlorine compound (HCl gas) at 600° C. Then, the roasted positive electrode plate was immersed in water for 30 minutes to obtain an Li solution. In this test, water collected from the water trap of the electric furnace was also added to the Li solution.

### (2) Sample 2

To prepare Sample 2, an Li solution was obtained under the same condition as for Sample 1 (first test) except that the heating temperature was changed to 927° C.

### 2. Evaluation Test

In this test, elements contained in the Li solution of each sample were analyzed by ICP. Specifically, water into which the test sample had been immersed (Li solution) was subjected to ICP analysis for Li, Ni, Co, Mn, and Al, without any pretreatment such as separation of specific elements. Based on the measurement result, a water leaching ratio of each element mentioned above was calculated. Calculation of this water leaching ratio was based on the following equation (2). Similarly to the above formula (1), the “atomic weight before roasting” refers to an atomic weight determined by analyzing a reference sample cut out from the positive electrode plate by ICP. The water leaching ratios of each element of samples 1 and 2 are presented in Table 1.

$$Water leaching ratio = ( atomic weight in Li solution / atomic weight in positive \\ electrode plate before roasting ) \times 100 \qquad ( 2 )$$

TABLE 1

| | Roasting temperature | Water leaching ratio (%) | | | | |
|---|---|---|---|---|---|---|
| | (° C.) | Li | Ni | Co | Mn | Al |
| Sample 1 | 600 | 91 | <1 | <1 | 54 | <1 |
| Sample 2 | 927 | 95 | <1 | <1 | 81 | <1 |

As presented in Table 1, a high Li recovery ratio of 90% or higher was confirmed for both samples 1 and 2. On the other hand, comparison between Sample 1 and Sample 2 showed that Sample 2 had a higher Li recovery ratio. This proved that the heating temperature was preferably 900° C. or higher in the chlorination heating step. It was also confirmed that the Li solution after the water leaching contained mainly Li and Mn, and little Ni, Co, and Al.

As described above, the technologies disclosed herein have been explained in detail, but these technologies are merely examples and are not intended to limit claims. The technologies described in claims include various variations and modifications of the specific examples illustrated above. That means, the technologies disclosed herein encompass configurations described in the following items 1 to 9.

### <Item 1>

A method for manufacturing a battery material, including:
a preparation step for preparing a recovery object containing at least Li; and
a chlorination heating step of heating the recovery object together with a non-metal chlorine compound to produce LiCl.

### <Item 2>

The method according to item 1, in which the non-metal chlorine compound contains at least one selected from hydrogen chloride, ammonium chloride, ammonium perchlorate, perchloric acid, chloric acid, hypochlorous acid, chloromethane, dichloromethane, trichloromethane, and tetrachloroethylene.

### <Item 3>

The method according to item 1 or 2, in which the chlorination heating step includes heating the recovery object at 500° C. to 1000° C.

### <Item 4>

The method according to any one of items 1 to 3, in which the chlorination heating step includes heating the recovery object under an inert atmosphere.

### <Item 5>

The method according to any one of items 1 to 4, in which the recovery object contains at least one selected from a group consisting of a lithium-nickel composite oxide, a lithium-cobalt composite oxide, a lithium-nickel-manganese composite oxide, a lithium-manganese-cobalt composite oxide, a lithium-nickel-cobalt composite oxide, a lithium-nickel-manganese-cobalt composite oxide, lithium iron phosphate, lithium manganese phosphate, and lithium ferromanganese phosphate.

### <Item 6>

The method according to any one of items 1 to 5, further including a water dissolution step of immersing the recovery object after the chlorination heating step in water to dissolve LiCl in water and to obtain an Li solution.

### <Item 7>

The method according to item 6, further including an Li crystallization step of precipitating an Li compound crystal from the Li solution.

### <Item 8>

The method according to item 6 or 7, in which the recovery object contains at least one of Ni and Co, and the method further includes an NH₃ leaching step of immersing a solid after the water dissolution step in an ammonia aqueous solution to obtain a metal solution containing at least one of Ni and Co.

### <Item 9>

The method according to item 3, in which the chlorination heating step includes heating the recovery object at 900° C. or higher.

What is claimed is:

1. A method for manufacturing a battery material, comprising:
a preparation step for preparing a recovery object containing at least Li; and
a chlorination heating step of heating the recovery object together with a non-metal chlorine compound to produce LiCl.

2. The method according to claim 1, wherein the non-metal chlorine compound contains at least one selected from hydrogen chloride, ammonium chloride, ammonium perchlorate, perchloric acid, chloric acid, hypochlorous acid, chloromethane, dichloromethane, trichloromethane, and tetrachloroethylene.

3. The method according to claim 1, wherein the chlorination heating step comprises heating the recovery object at 500° C. to 1000° C.

4. The method according to claim 1, wherein the chlorination heating step comprises heating the recovery object under an inert atmosphere.

5. The method according to claim 1, wherein the recovery object contains at least one selected from a group consisting of a lithium-nickel composite oxide, a lithium-cobalt composite oxide, a lithium-nickel-manganese composite oxide, a lithium-manganese-cobalt composite oxide, a lithium-nickel-cobalt composite oxide, a lithium-nickel-manganese-cobalt composite oxide, lithium iron phosphate, lithium manganese phosphate, and lithium ferromanganese phosphate.

6. The method according to claim 1, further comprising a water dissolution step of immersing the recovery object after the chlorination heating step in water to dissolve LiCl in water to obtain an Li solution.

7. The method according to claim 6, further comprising an Li crystallization step of precipitating an Li compound crystal from the Li solution.

8. The method according to claim 6, wherein the recovery object contains at least one of Ni and Co, and the method further comprises an NH₃ leaching step of immersing a solid after the water dissolution step in an ammonia aqueous solution to obtain a metal solution containing at least one of Ni and Co.

9. The method according to claim 3, wherein the chlorination heating step comprises heating the recovery object at 900° C. or higher.
